(19) United States
(12) Patent Application Publication
(10) Pub. No.: US 2009/0122556 A1
(43) Pub. Date: May 14, 2009

(54) Light fitting

(75) Inventors: Richard Cuthbert, Bristol (GB); Matthew Lloyd, Bristol (GB)

Correspondence Address: SHUMAKER & SIEFFERT, P. A., 1625 RADIO DRIVE, SUITE 300, WOODBURY, MN, 55125, US

(73) Assignee: Global Design Solutions Limited, Bristol (GB)

(21) Appl. No.: 11/912,230

(22) PCT Filed: Apr. 24, 2006
(86) PCT No.: PCT/GB06/01485

§ 371 Date: May 30, 2008

(30) Foreign Application Priority Data
Apr. 22, 2005 (GB) 0508141.9

(51) Int. Cl. F21V 3/02; F21V 15/01; F21V 7/00

(52) U.S. Cl. 362/307; 362/362; 362/311.01

(57) ABSTRACT

This invention relates to light fittings and in particular light fittings which produce a uniform and soft light or a predetermined focused beam of light.

### FIELD OF THE INVENTION

This invention relates to light fittings and in particular light fittings which produce a uniform and soft light or a predetermined focused beam of light.

### BACKGROUND TO THE INVENTION

Light fittings are known which produce a relatively small amount of uniform light, for instance, in emergency situations when the normal electric power has been interrupted or to provide indication of where a particular installation is located or as part of a light path to, for instance, an emergency exit.

Electrical conduit boxes are widespread and they provide a useful position at which to locate a light source.

### STATEMENTS OF THE INVENTION

According to the present invention there is provided a light fitting for attachment to a standard electrical conduit box, the fitting comprising a light transmitting cover attachable to said box to provide, together with said box, a housing, and a light source for location within the housing.

An embodiment of this invention which provides an omnidirectional light fitting is referred to as BlueDome™. This light fitting is preferably provided with a centrally located domed light transmitting cover.

A further embodiment of this invention provides a directional light fitting, referred to as BlueBeam™. In this embodiment of the invention the moulded housing is provided with a mirrored reflector which focuses the light into a narrow beam which is then transmitted through a lens provided at the front of the moulded housing. Preferably the lens is inserted into a cavity provided within the front of moulded housing. Even more preferably this lens is a thin plastic lens sheet, which may for example be of a round shape to match the moulding. The use of different types of lens enables the beam of light to be adjusted to different angles. Where uneven beam shapes are required the lens provided may produce an elliptical beam shape.

By way of example, the light transmitting cover may be a polycarbonate injection moulded dome which is mountable on the electrical conduit box by means of two bolt-holes.

Preferably the light source is an LED light source.

Again by way of example the LED light source may be one which provides a blue, red, green, white or amber light.

### BRIEF DESCRIPTION OF THE DRAWINGS

The accompanying drawings are as follows:

FIGS. 1 and 2 represent perspective views of the BlueBeam™ light fitting in accordance with the present invention;

FIGS. 3 and 4 represent perspective views of the BlueDome™ light fitting in accordance with the present invention;

FIG. 5 is a perspective view of the under surface of the BlueBeam™ or BlueDome™ light fittings.

FIG. 6 is a side view of the BlueBeam™ light fitting.

### DETAILED DESCRIPTION OF THE INVENTION

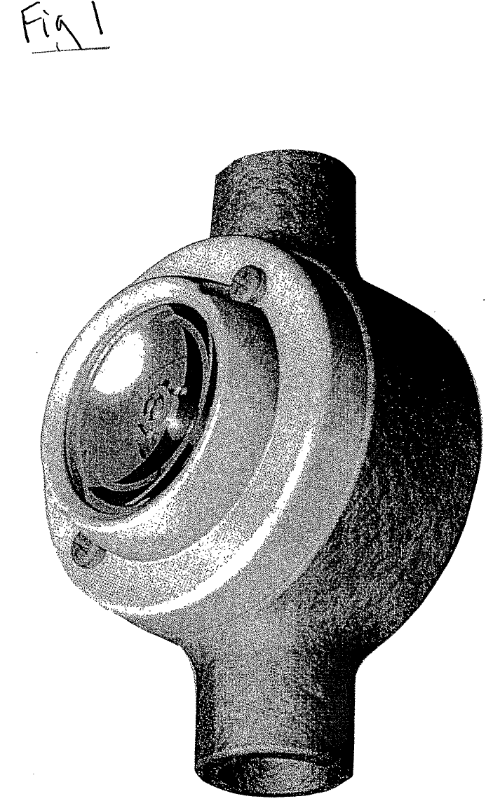

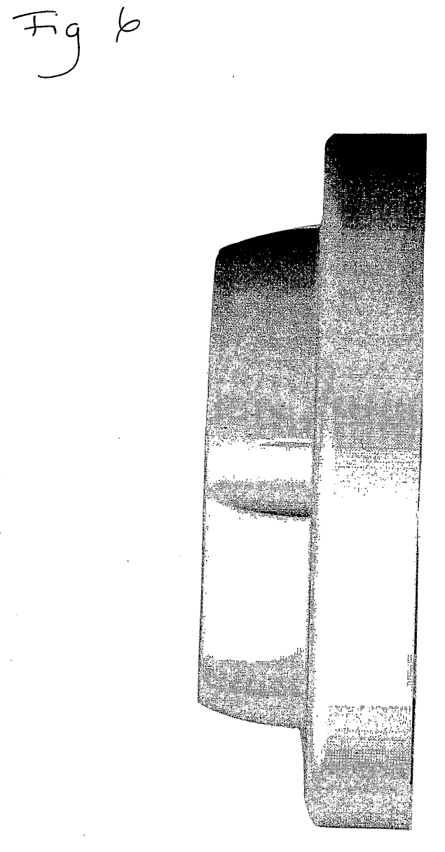

Referring to FIGS. 1 to 6 of the accompanying drawings two alternative fittings for a light source in accordance with the present invention are illustrated.

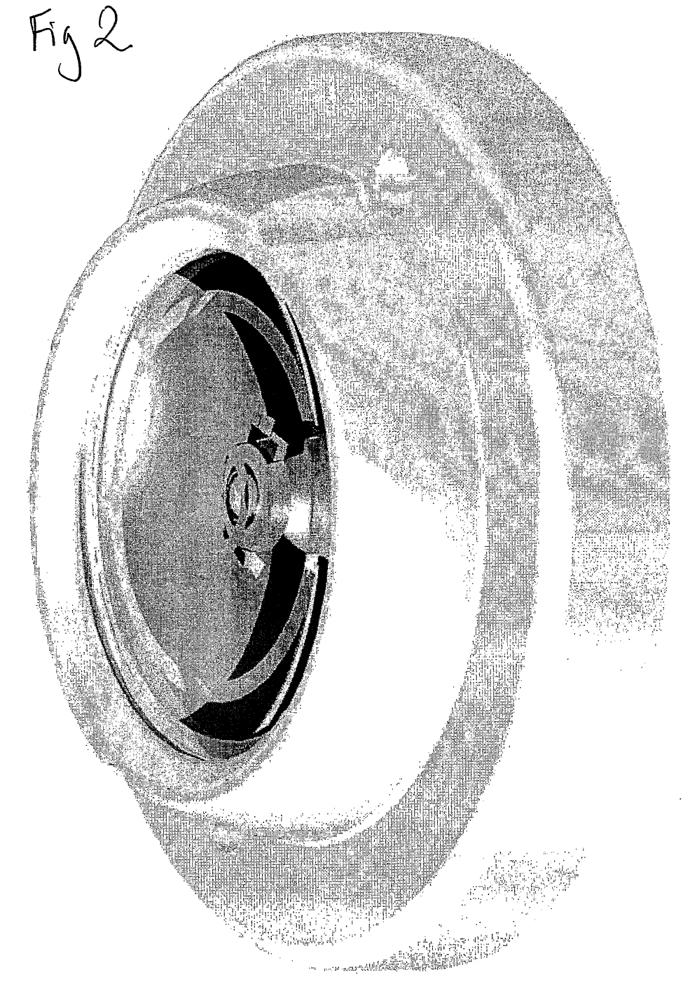

FIGS. 1 and 2 illustrate the BlueBeam™ fitting having a central orifice with reflector surrounded by a continuous peripheral ledge from which depends a peripheral flange.

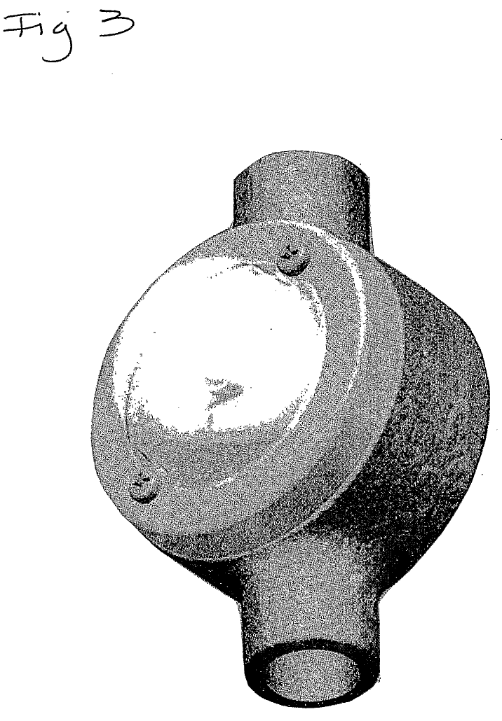

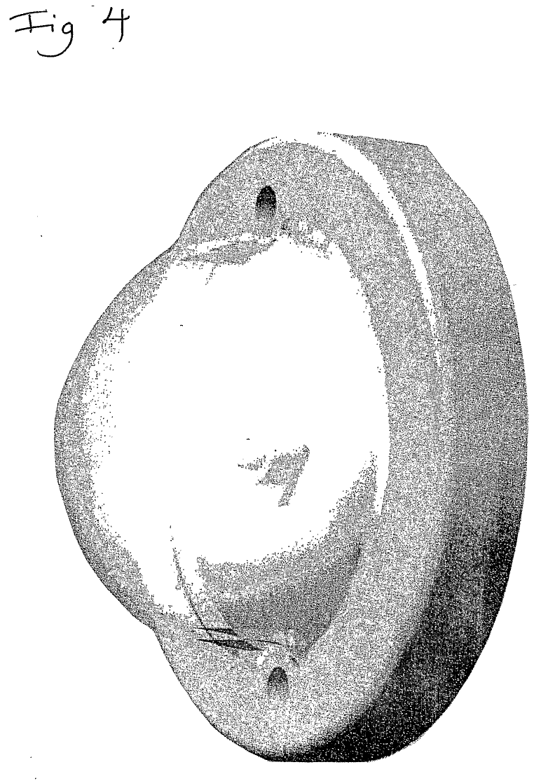

FIGS. 3 and 4 illustrate the BlueDome™ fitting having a centralised polycarbonate injection moulded domed cover (FIGS. 3 and 4).

The size and shape of each style of fitting is such that it is easily mountable via two bolt-holes on a standard electrical conduit box. FIGS. 1 and 2 illustrate the fittings with bolts located thereon showing the underlying standard electrical conduit box.

The pitch between the two mounting holes is approximately 48-52 mm, this pitch being centred around the middle axis of the fitting. By the use of such an arrangement the light fitting of the invention can be used with many different back boxes.

The fittings illustrated in FIGS. 1 to 6 provides, together with the electrical conduit box to which it is fitted, a housing within which is located a light source such as a Luxeon 3W emitter which is mounted on an aluminium heat plane. The aluminium heat plane fits around the mounting holes in the moulding to achieve maximum surface area for the dissipation of heat.

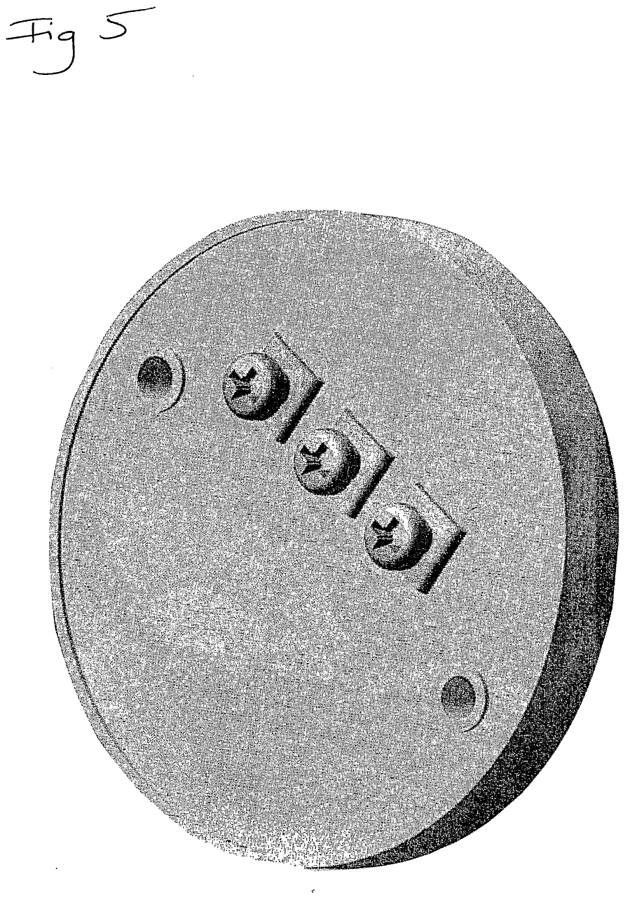

The LED source is dimmable from 0 to 100%. The cabling to the unit is via terminal connections on the rear of the unit (FIG. 5). The unit is constantly fed 11-36 VDC with a 0-10 v control line to adjust brightness.

The above described unit is not affected by any combination of 24 VDC on the input terminals, that is to say, it is short circuit protected. The unit can be run at full power by bridging control and +24 VDC at the dome.

The above described light fittings may be such that zero maintenance is required. In particular all components are potted and the unit is sealed and therefore can be used outside.

1. A standard electrical conduit box provided with a light fitting, the light fitting comprising a light transmitting cover, the light fitting being attachable to said box to provide, together with said box, a housing, and a light source for location within the housing.

2. An electrical conduit box according to claim 1, wherein the light transmitting cover is a centrally located domed element.

3. An electrical conduit box according to claim 1, wherein the light transmitting cover is a moulded ring provided with a lens.

4. An electrical conduit box according to claim 3, wherein the lens is provided in a cavity in the front of the moulded housing.

5. An electrical conduit box according to claim 3, wherein the lens is domed.

6. An electrical conduit box according to claim 3, wherein the lens comprises a thin sleet of material.

7. An electrical conduit box according to claim 3, wherein the glens is configured to provide an elliptical beam shape.

8. An electrical conduit box according to claim 3, wherein the housing is further provided with a mirrored reflector for focusing the light into a narrow beam for transmission through the lens.

9. An electrical conduit box according to claim 1, wherein the light fitting is injection moulded polycarbonate.

10. An electrical conduit box according to claim 1, wherein the light source is a LED.

11. An electrical conduit box according to claim 1 configured such that the light source is dimmable.

12. An electrical conduit box wherein the light fitting is configured to be mounted to the conduit box.

13. A method comprising the steps of:
providing a standard electrical conduit box;
providing a light fitting comprising a light transmitting cover, the light fitting being attachable to said box to provide, together with said box, a housing; and
providing a light source for location within the housing.

14. A method according to claim 13, wherein the light transmitting cover is a centrally located domed element.

15. A method according to claim 13, wherein the light transmitting cover is a moulded ring provided with a lens.

16. A method according to claim 15, wherein the lens is provided in a cavity in the front of the moulded housing.

17. A method according to claim 15, wherein the lens is domed.

18. A method according to claim 15, wherein the lens comprises a thin sheet of material.

19. A method according to claim 15, wherein the lens is configured to provide an elliptical beam shape.

20. A method according to claim 15, wherein the housing is further provided with a mirrored reflector for focusing the light into a narrow beam for transmission through the lens.

21. A method according to claim 13, wherein the light fitting is injection moulded polycarbonate.

22. A method according to claim 13, wherein the light source is a LED.

23. A method according to claim 13 configured such that the light source is dimmable.
